(19) United States
(12) Patent Application Publication
(10) Pub. No.: US 2004/0025643 A1
(43) Pub. Date: Feb. 12, 2004

(54) Ratchet wheel mounting structure for wrench

(76) Inventor: Chih-Ching Hsien, Taichung (TW)

Correspondence Address: Chih-Ching Hsien, 235 Chung-Ho, Box 8-24, Taipei, TW

(21) Appl. No.: 10/213,301

(22) Filed: Aug. 7, 2002

(51) Int. Cl. B25B 13/46

(52) U.S. Cl. 81/60

(57) ABSTRACT

A ratchet wheel mounting structure includes a ratchet wheel mounted in the box of a wrench and meshed with a toothed stop block in the box, and a retainer ring, which secures the ratchet wheel to the box. The pressure angle of the ratchet wheel is within 10˜13°. Each tooth of the ratchet wheel has a chamfer angle at each of two distal ends thereof. A reinforcing bevel angle is provided in the valley between the roots of each two adjacent teeth of the ratchet wheel adjacent to the locating block.

### BACKGROUND OF THE INVENTION

The present invention relates to wrenches, and more specifically, to a ratchet wheel mounting structure for wrench, which achieves high performance.

FIGS. 1 and 2 show two different ratchet wheel designs according to the prior art. These ratchet wheels are made through latching and milling processes, having R-angle or straight teeth. The teeth of these ratchet wheels wear quickly with use and have a low torque value. Further, when meshed with the toothed stop block in the box of the wrench, output of force is not fully transmitted from the wrench to the ratchet wheel and then to the workpiece. FIG. 3 shows still another design of ratchet wheel according to the prior art. According to this design, the ratchet wheel has a disk-like reinforcing structure integral with the teeth at one end to reinforce the structural strength of the teeth. In either of the aforesaid three prior art ratchet wheel designs, the two distal ends of each tooth of the ratchet wheel are of right angle design. When twisted with the wrench to rotate the workpiece the teeth of the ratchet wheel may break easily, and the friction between the ends of each tooth of the ratchet wheel and the inside wall of the box of the wrench affects the performance of the wrench. Another drawback of the aforesaid prior art ratchet wheel designs is the installation difficulty of the C-shaped retainer ring. Because the width of the two distal ends of the C-shaped retainer ring that secures the ratchet wheel in the box of the wrench is equal to the width of the locating groove of the ratchet wheel, it is not easy to fasten the C-shaped retainer ring to the locating grove of the ratchet wheel. Furthermore, because the pressure angle of the aforesaid prior art ratchet wheel designs is 14.5° or 20°, the engagement between the teeth and the stop block is not in coincidence with the pressure line, resulting in weak structural strength.

### SUMMARY OF THE INVENTION

The present invention has been accomplished to provide a ratchet wheel mounting structure, which eliminates the aforesaid drawbacks. It is one object of the present invention to provide a ratchet wheel mounting structure, which is durable in use. It is another object of the present invention to provide a ratchet wheel mounting structure, which achieves high performance. According to one aspect of the present invention, each tooth of the ratchet wheel has a chamfer angle at each of two distal ends thereof so that the teeth of the ratchet wheel do not break when rotating the workpiece. According to another aspect of the present invention, a reinforcing bevel angle is provided in the valley between the roots of each two adjacent teeth of the ratchet wheel adjacent to the locating block to reinforce the structural strength of the teeth of the ratchet wheel. According to still another aspect of the present invention, the pressure angle of the ratchet wheel is within 10˜13°, so that the engagement between the teeth of the ratchet wheel and the toothed stop block is in coincidence with the pressure line, so that applied force is fully transmitted to the ratchet wheel and the workpiece.

### BRIEF DESCRIPTION OF THE DRAWINGS

FIG. 1 illustrates a ratchet wheel for wrench according to the prior art.

FIG. 2 illustrates another structure of ratchet wheel for wrench according to the prior art.

FIG. 3 illustrates still another structure of ratchet wheel for wrench according to the prior art.

FIG. 4 is an exploded view showing the structure of a ratchet wheel and a C-shaped retainer ring according to the present invention.

FIG. 5 is a plain end view of the ratchet wheel according to the present invention.

FIG. 6 is a schematic drawing explaining the design of the chamfer angle of the teeth of the ratchet wheel.

FIG. 7 is a side view of the ratchet wheel according to the present invention.

FIG. 8 is a side view of an alternate form of the ratchet wheel according to the present invention.

FIG. 9 is a schematic drawing explaining the design of the best pressure angle.

FIG. 10 is a schematic drawing explaining the design of equal angle tooth form according to the present invention.

FIG. 11 is a schematic drawing explaining the design of unequal angle tooth form according to the present invention.

FIG. 12 is a plain view of a ratchet wheel with teeth of equal angle tooth form according to the present invention.

FIG. 13 is a plain view of a ratchet wheel with teeth of unequal angle tooth form according to the present invention.

FIG. 14 is a schematic drawing explaining the design of the C-shaped retainer ring according to the present invention.

FIG. 15 is a schematic drawing explaining the design of the cut angles of the C-shaped retainer ring according to the present invention.

FIG. 16 is a sectional view showing the ratchet wheel installed in the box of the wrench and meshed with the toothed block in the box according to the present invention.

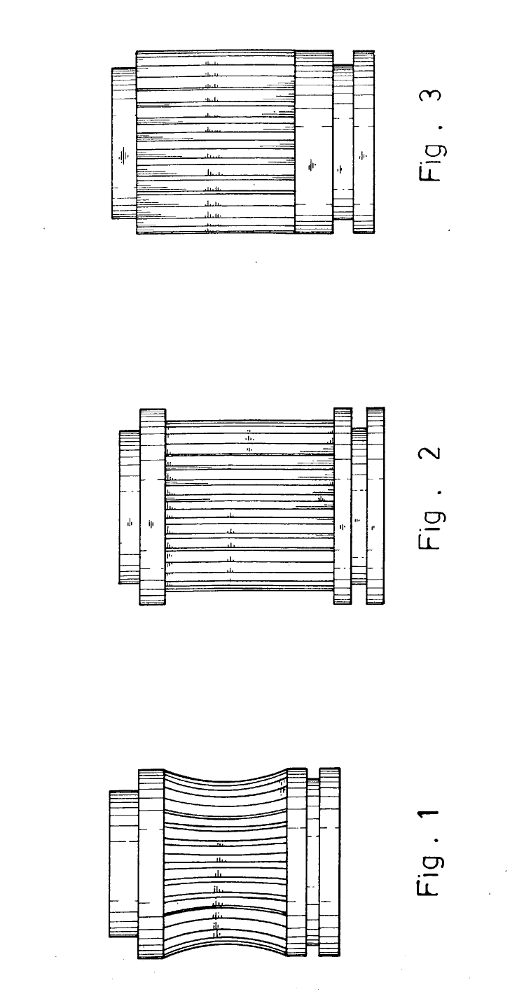

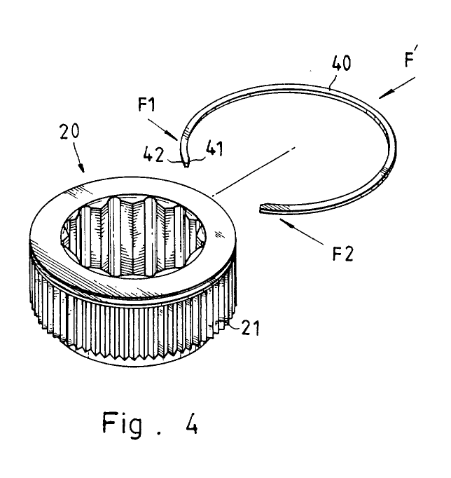

### DETAILED DESCRIPTION OF THE PREFERRED EMBODIMENT

Referring to FIGS. from 4 through 16 a ratchet wheel 20 and a stop block 30 are mounted in the box 11 of a wrench body 10. The stop block 30 is a toothed member engaged with the ratchet wheel 20 and adapted to control the direction of rotation of the ratchet wheel 20.

The ratchet wheel 20 has teeth 21 arranged around the periphery thereof, a locating block 22 at one side thereof, and a locating groove 221 extended around the locating block 22 for the positioning of a retainer ring 40, which secures the ratchet wheel 20 to the inside of the box 11 of the wrench body 10. The outer diameter of the locating block 21 is equal to the outer diameter around the teeth 21. Each tooth 21 has a chamfer angle 211 at one or each of the two distal ends thereof. The chamber angle 211 is determined subject to “tan ° C.=H1/D” so that “H1=D* tan ° C.”, in which D=height of tooth. Further, a reinforcing bevel angle 212 is provided in the valley between the roots of each two adjacent teeth 21 adjacent to the locating block 22 that reinforces the structural strength of the teeth for smooth rotation. The retainer ring 40 is a C-shaped ring, having two cut angles 41 and 42 disposed at top and bottom sides of each of the two ends thereof for quick installation. By means of the aforesaid features the ratchet wheel 20 is strong and wear resistant, and can easily be installed in the wrench for smooth operation.

Unlike the 20° or 14.5° pressure angle of conventional designs, the pressure angle of the ratchet wheel 20 is within 10˜13°. The ratchet wheel 20 has its teeth 21 meshed with the stop block 30 along a pressure line for positive positioning. Further, the tooth form of the teeth 21 can be of bevel gear type or spur gear type.

As shown in FIG. 9, the engagement between the stop block 30 and the ratchet wheel 21 extends along a pressure line if the pressure angle of the ratchet wheel 20 is set within 10˜13°. In this case, the applied force F of the wrench drives the teeth 21 of the ratchet wheel 20 perpendicularly. According to the principle of transmission of force, the output of force is 100% when pushing the load with a force F at right angle. If a force F is applied to the workpiece at a tilted angle, an ineffective component of force will be produced during the output of force F, and the output of force will be below 100% in this case. The greater the contained angle of the tilted output force is the greater the ineffective component of force will be. By means of the aforesaid tooth form, the effective component of force to the ratchet wheel is greatly increased to improve the working efficiency of the wrench.

Referring to FIGS. from 10 through 13, the teeth of the ratchet wheel can be either of symmetrical type of equal angle design, or unsymmetrical type of unequal angle design.

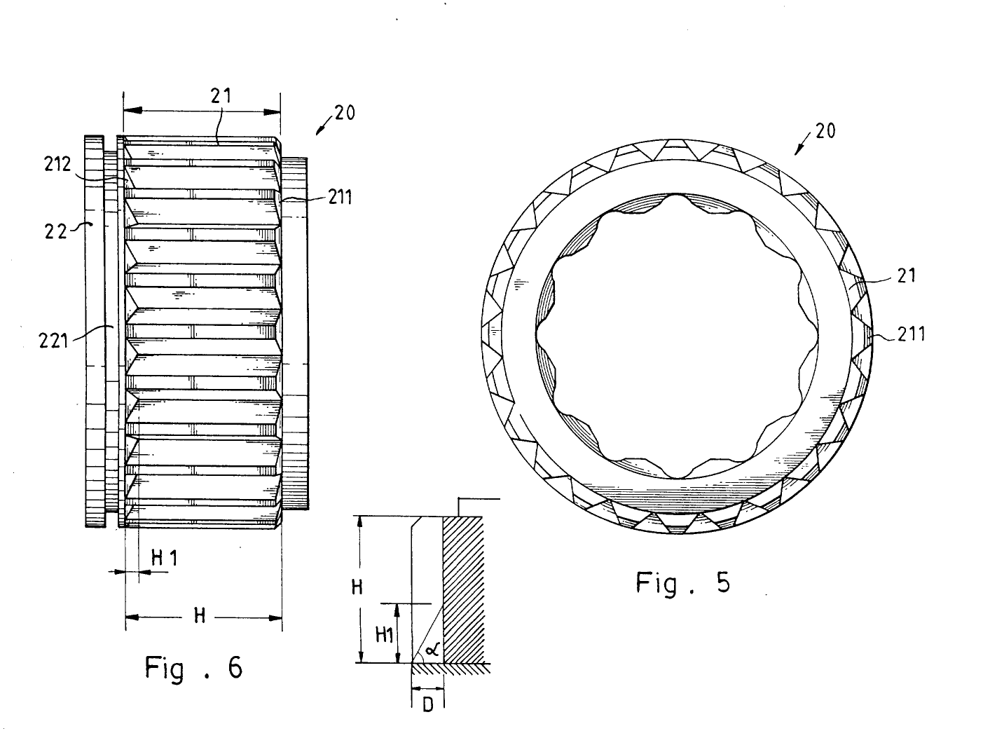

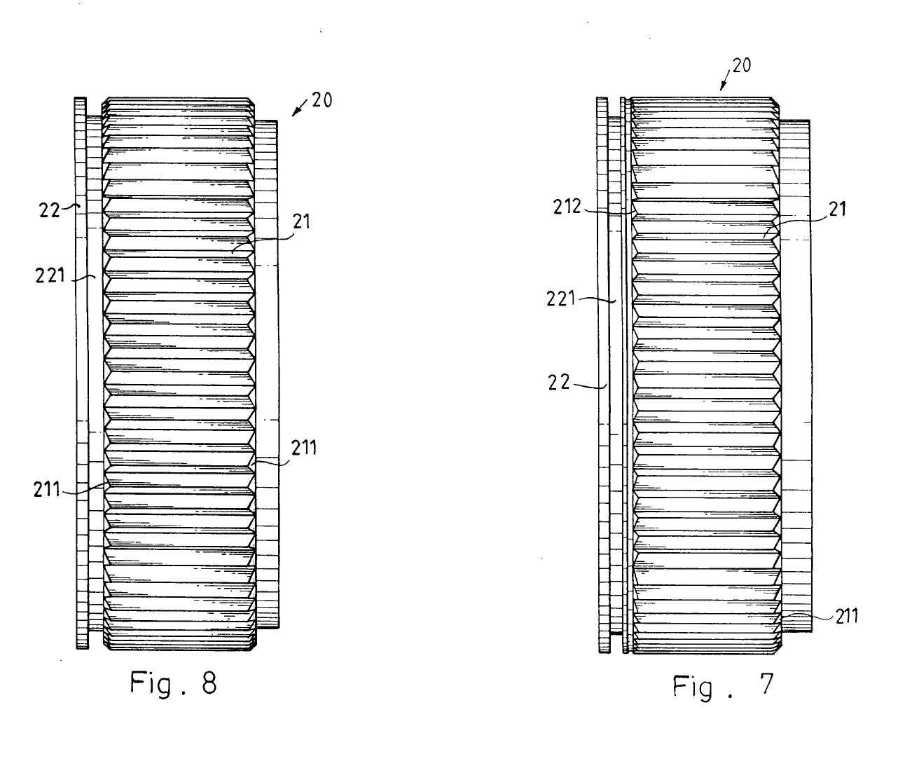

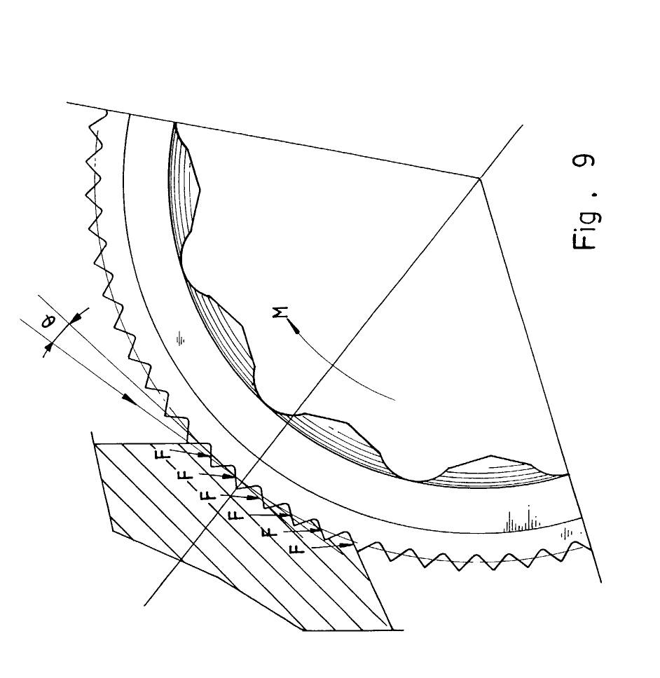

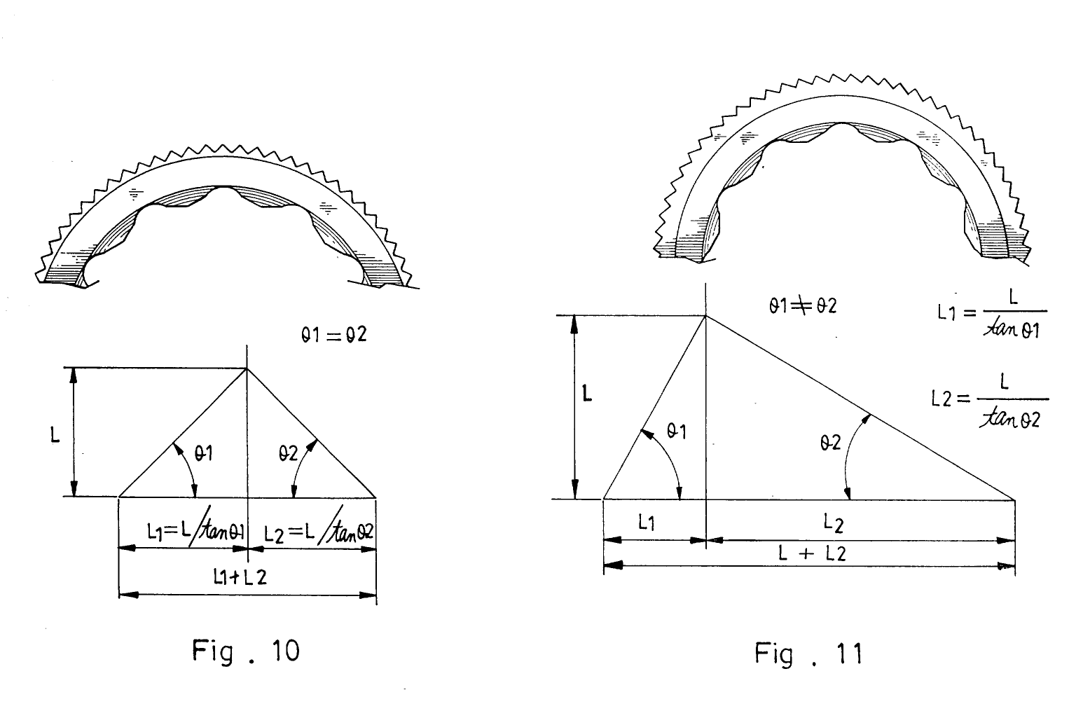

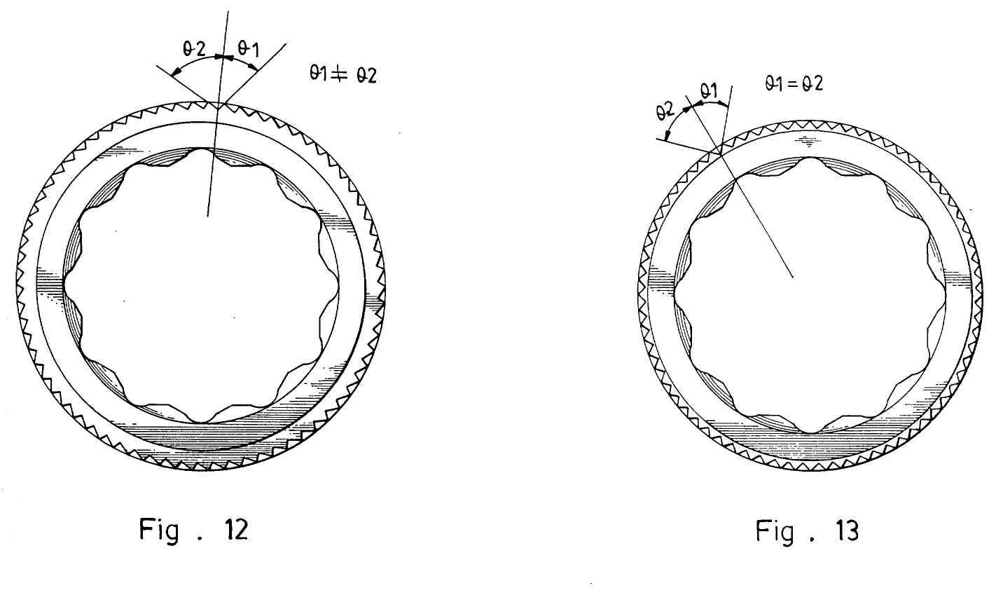

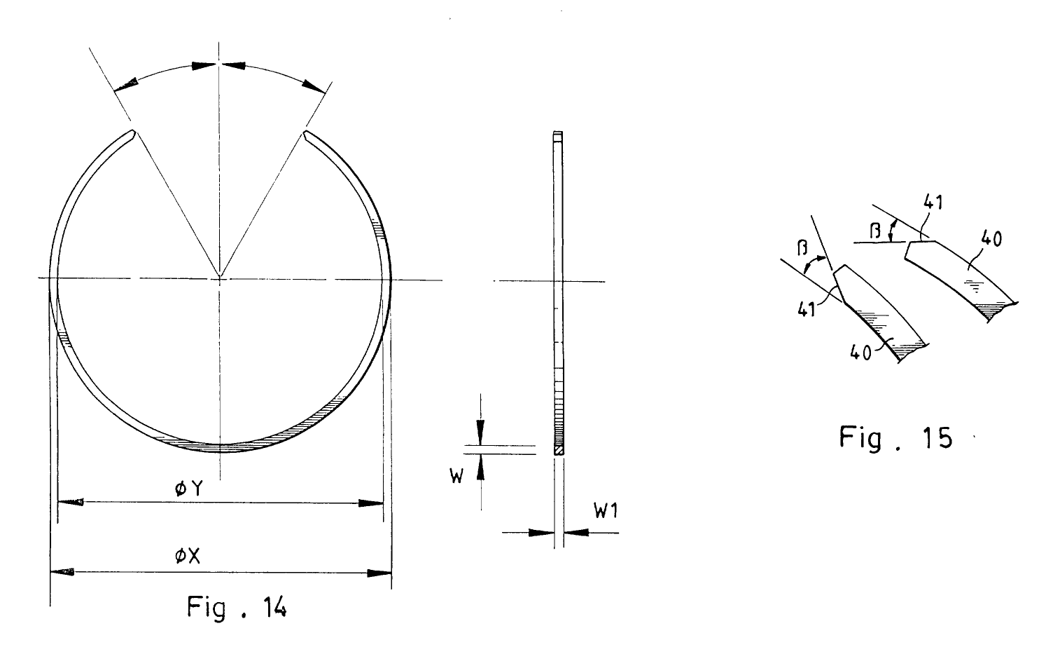

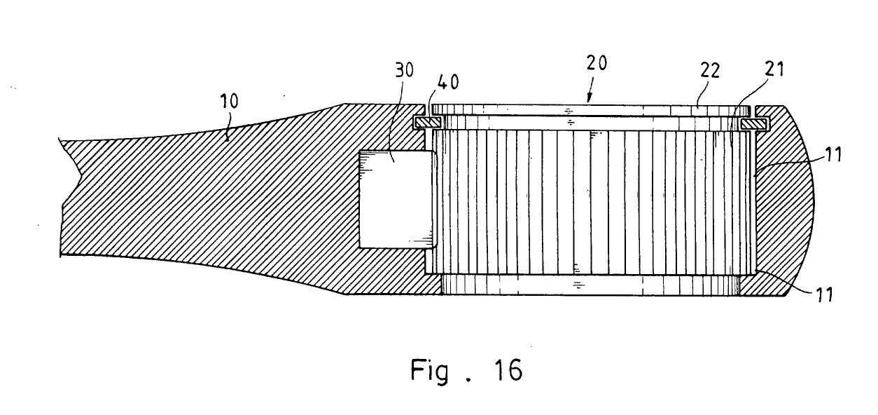

A prototype of ratchet wheel for wrench has been constructed with the features of FIGS. 4-16. The ratchet wheel for wrench functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A ratchet wheel mounting structure comprising a ratchet wheel mounted in the box of a wrench body and meshed with a toothed stop block in said box and, and a retainer ring mounted in between said box and said ratchet wheel to secure said ratchet wheel to said box, said ratchet wheel having teeth arranged around the periphery thereof, a locating block at one side thereof, and a locating groove extended around the periphery of said locating block for the positioning of said retainer ring, wherein each tooth of said ratchet wheel has a chamfer angle at each of two distal ends thereof; a reinforcing bevel angle is provided in the valley between the root of each two adjacent teeth of said ratchet wheel adjacent to said locating block.

2. The ratchet wheel mounting structure as claimed in claim 1 wherein said retainer ring has two cut angles disposed at top and bottom sides of each of two distal ends thereof.

3. A ratchet wheel mounting structure comprising a ratchet wheel mounted in the box of a wrench body and meshed with a toothed stop block in said box and, and a retainer ring mounted in between said box and said ratchet wheel to secure said ratchet wheel to said box, said ratchet wheel having teeth arranged around the periphery thereof, a locating block at one side thereof, and a locating groove extended around the periphery of said locating block for the positioning of said retainer ring, wherein the pressure angle of said ratchet wheel is within 10˜13°; each tooth of said ratchet wheel has a chamfer angle at each of two distal ends thereof; a reinforcing bevel angle is provided in the valley between the root of each two adjacent teeth of said ratchet wheel adjacent to said locating block.

4. The ratchet wheel mounting structure as claimed in claim 3 wherein said retainer ring has two cut angles disposed at top and bottom sides of each of two distal ends thereof.
